(19) United States
(12) Patent Application Publication
(10) Pub. No.: US 2008/0120098 A1
(43) Pub. Date: May 22, 2008

(54) Complexity Adjustment for a Signal Encoder

(75) Inventors: Jari M. Makinen, Tampere (FI); Juha Marila, Harjavalta (FI); Hannu J. Mikkola, Tampere (FI); Janne Vainio, Pirkkala (FI); Tuomas Vaittinen, Helsinki (FI); Sakari Himanen, Tampere (FI); Kai K. Samposalo, Tampere (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/562,067

(22) Filed: Nov. 21, 2006

(51) Int. Cl. G10L 19/00

(52) U.S. Cl. 704/222; 704/E19.003

(57) ABSTRACT

The present invention provides, methods, computer-readable media, and apparatuses for tuning and adjusting the computational complexity of algorithm that is executed by a signal encoder. The signal encoder may comprise a speech encoder. When a resource shortage on a computer platform is detected, a degree of the resource shortage and a corresponding complexity adjustment for a speech encoder are determined. The speech encoder is then tuned to adjust the computational complexity of an executed speech processing algorithm. The resource shortage may correspond to a computational capability, audio buffer memory, or battery of a mobile device. A speech process being executed by the mobile device is tuned to adjust the computational demands in accordance with a complexity adjustment. A number of iteration rounds may be adjusted while the speech encoder is executing a speech processing algorithm. The iterations may correspond to an algebraic codebook search.

### FIELD OF THE INVENTION

The present invention relates to adjusting a computational complexity of a signal encoder based on a resource shortage. The signal encoder may comprise a speech encoder.

### BACKGROUND OF THE INVENTION

Speech processing by a mobile device is often a complex process, thus taxing the available resources of the mobile device. For example, a wideband adaptive multi-rate (AMR-WB). AMR-WB is relatively high complex process and thus can utilize a significant portion of a mobile device's resources, e.g., computational resources and memory resources. Moreover, the mobile device may be simultaneously executing other processes. If any of the needed resources exceed the available resources, a corresponding service may not be completed in a timely basis, causing a perceived problem by the user.

With advanced services that are currently supported and that will be supported in the future, the demands on available resources of a mobile device are continuously increasing. Reducing the demands on the resources of mobile device may enable the mobile device to better execute a plurality of processes. Consequently, the support of advanced services on a mobile device is facilitated.

### BRIEF SUMMARY OF THE INVENTION

An aspect of the present invention provides methods, computer-readable media, and apparatuses for tuning and adjusting the computational complexity of algorithm that is executed by a signal encoder. The signal encoder may comprise a speech encoder.

With an aspect of the invention, a resource shortage on a computer platform is detected. A degree of the resource shortage and a corresponding complexity adjustment for a speech encoder are determined. The speech encoder is then tuned to adjust the computational complexity of an executed speech processing algorithm.

With another aspect of the invention, the resource shortage may correspond to a computational capability, audio buffer memory, or battery of a mobile device. A speech process being executed by the mobile device is tuned to adjust the computational demands in accordance with a complexity adjustment.

With another aspect of the invention, a number of iteration rounds is adjusted while the speech encoder is executing a speech processing algorithm. The iterations may correspond to an algebraic codebook search.

With another aspect of the invention, when the resource shortage ceases, a complexity adjustment returns a speech encoder to normal operation.

With another aspect of the invention, resource availability may increase sufficiently so that the computational complexity of a signal encoder may be increased.

### BRIEF DESCRIPTION OF THE DRAWINGS

A more complete understanding of the present invention and the advantages thereof may be acquired by referring to the following description in consideration of the accompanying drawings, in which like reference numbers indicate like features and wherein:

FIG. 1 shows a computer system that utilizes a complexity adjustment in accordance with an embodiment of the invention.

FIG. 2 shows an input audio buffer that utilizes complexity adjustment in accordance with an embodiment of the invention.

FIG. 3 shows a wideband adaptive multi-rate (AMR) speech coder in accordance with an embodiment of the invention.

FIG. 4 shows a flow diagram for controlling a complexity adjustment of an adjustable speech encoder in accordance with an embodiment of the invention.

FIG. 5 shows audio quality in relation to a number of iterations in accordance with an embodiment of the invention.

FIG. 6 shows speech encoder computational complexity in relation to a number of iterations in accordance with an embodiment of the invention.

### DETAILED DESCRIPTION OF THE INVENTION

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

### Controlling Algebraic Codebook Search

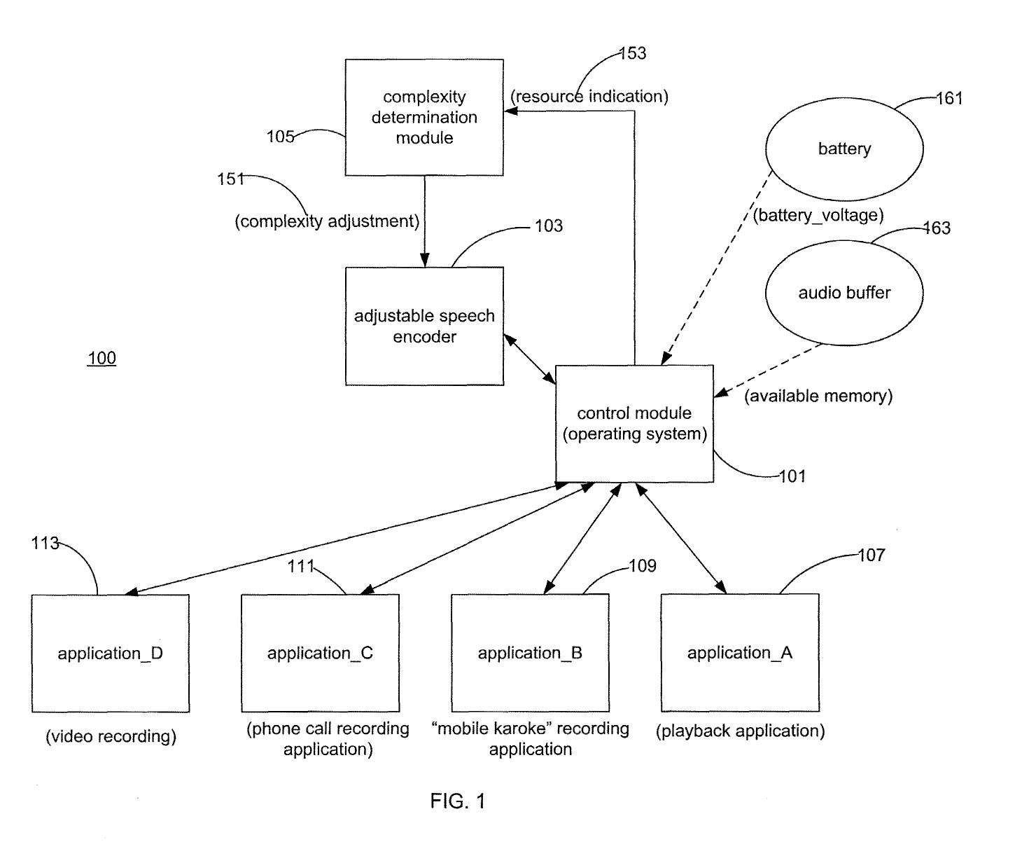

FIG. 1 shows computer system 100 that utilizes a complexity adjustment in accordance with an embodiment of the invention.

The prior art typically uses a standard Third Generation Project Plan (3GPP) Wideband Adaptive Multi-rate (AMR-WB) speech encoding having a fixed number of iteration rounds for each encoding mode. For example, AMR-WB mode at 23.85 kbps uses three iteration rounds, and AMR-WB mode at 23.05 kbps utilizes four iteration rounds for an algebraic codebook search.

As shown in FIG. 1, an embodiment of the invention adaptively selects a determined number of iteration rounds for AMR-WB encoding from an application level. Consequently, the number of iteration rounds can be adapted based on computational load of mobile devices or by some other means or requirements. AMR-WB is a relatively high complex process that executes on mobile devices; thus, the embodiment of the invention may decrease the AMR-WB encoding complexity by adapting the number of iteration rounds of the codebook search. This approach releases computational resources on mobiles devices and thus enables simultaneous processes.

With an embodiment of the invention, the number of iteration rounds can be adaptively controlled during the encoding process on a frame-by-frame basis. Even during encoding one frame (typically having a 20 msec duration), the AMR-WB complexity can be decreased. This approach may enable good performance during unexpected peak computational load. After the peak computation load has ended, encoding can return to normal operation, in which the original, fixed number of iteration rounds provides standard performance.

Computer system 100 includes control module (operating system) 101 which administers resources, e.g., battery 161, audio buffer memory 163, and processing (CPU) resources (not shown), to applications (processes) 107-113 and speech encoding 103. For example, application 107 provides playback capability for a MP3 musical recording, application 109 supports “mobile karaoke,” application supports telephone call recording, and application 113 supports video recording. Computer system may support one or more applications at a given time.

Control module 101 administers the resources of computer system 100 and assigns the resources to applications 107-113 and speech encoding process 103 in accordance with the needs and the priorities of the processes. When a resource shortage is detected by control module 101, control module 101 provides a resource indication 153 to complexity determination module 105, where resource indication 153 is indicative of a degree of the resource shortage for the corresponding resource. (With embodiments of the invention, control module 101 and complexity determination module 105 may be combined into one module.) Complexity determination module 105 subsequently determines complexity adjustment 151 that tunes adjustable speech encoder 103 in order to control the computational complexity of the speech processing algorithm being executed by adjustable speech encoder 103. With an embodiment of the invention, the number of iterative rounds (as will be further discussed), is determined by complexity determination module 105 to adjust the computational complexity.

Unexpected computational load may be caused by high priority processes. For example, when a telephone call is incoming, the telephone call is serviced by a high priority process and may consume a substantial portion of a computational resource. Because mobile devices typically have limited computational resources, there is a possibility that the performance of low priority processes (e.g., voice/audio recording applications 111 and 113) may be degraded. In fact, it is possible that low priority processes cannot even be executed.

An embodiment of the invention may be utilized to decrease the computational load, for example, when battery 161 has been sufficiently discharged (corresponding to a low energy level). When a low battery lifetime notification is indicated by operation system 101 of the handset, adjustable speech encoder 103 can be configured to a low complex “mode” according to an embodiment to preserve battery lifetime. As will be further discussed, adjustable speech encoder may utilize an AMR-WB algorithm.

Embodiments of the invention support other types of encoders, e.g., video encoders and image encoders, in which complexity reduction is possible for the associated encoding algorithm during the encoding/compression process without changing the bit rate/bit stream and without losing the compatibility with the decoder.

With an embodiment of the invention, the number of search iterations for an algebraic codebook search algorithm can be tuned based on the computational load of a mobile device. By decreasing the number of iteration rounds, the AMR-WB encoding complexity can be decreased with acceptable audio quality degradation. While AMR-WB encoding is a relatively complex algorithm to execute on mobile devices, it is important to decrease AMR-WB encoding complexity to support simultaneous processes having a higher priority. An exemplary embodiment includes an AMR-WB encoder-enabled audio recorder, where other playback or audio capture functionalities are supported (for example, background music generation).

An embodiment of the invention provides a method to adjust encoding complexity of an adjustable speech encoder that is consistent with a standard 3GPP AMR-WB speech codec executing on a mobile device platform. While mobile terminals typically have limited computational resources, complexity requirements are often stringent for executing processes, e.g., encoding and decoding algorithms. Also, simultaneous processes often must execute. An embodiment facilitates tuning an AMR-WB speech encoder to control the computational requirement during a high computational load for a mobile device.

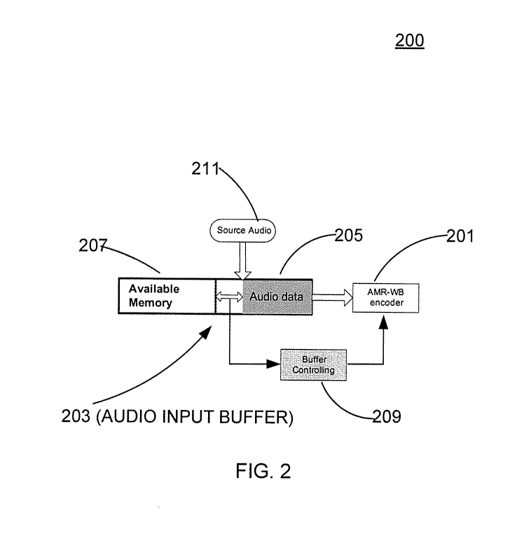

FIG. 2 shows input audio buffer 200 that utilizes complexity adjustment in accordance with an embodiment of the invention. The embodiment may be utilized for an audio recording application (e.g., process 109 as shown in FIG. 1), where advanced recording functionalities may require simultaneous processes, thus placing an excessive demand on the resources of mobile platform. One example is “mobile karaoke” recording, where the recording application with AMR-WB encoding and playback of a music player execute on mobile device. Also, recording of phone calls and video recording may require simultaneous processes to execute, thus decreased complexity of AMR-WB encoding may be configured.

With an embodiment of the invention, recording is supported with fixed audio input buffer 203 as shown in FIG. 2. While the recording application utilizes audio input buffer 203, the buffering may be controlled by buffer control 209.

With prior art, sufficiently large buffers are typically used to avoid recording interruptions, which may be caused by unexpected computational load or other reasons which has an effect on the audio encoding performance. With prior art, buffer control is often achieved by changing the length of the buffer.

With mobile devices, short buffers are suitable because of the limited memory space in mobile devices. Also, a desired requirement for a recording application is that the recording length not be limited (e.g. 1 minute recording) and that the recording length be based on available storage space (e.g. memory card).

While short audio buffer and unlimited recording are desirable, audio input buffer 200 is controlled to avoid buffer overflow and emptying. Buffer overflow may occur if enough computational resources are not available for buffer emptying (by encoding/compressing the buffer data), while the buffer is filled (corresponding to audio data 205) by audio source 211 (e.g., a microphone). With buffered recording, it may be necessary to catch up with the real-time recording before the recording operation is finished. An embodiment of the invention may be utilized to enable quicker encoding of a recording buffer in order to do so.

Buffer controlling can be achieved, in accordance with an embodiment of the invention, in which the AMR-WB encoder complexity may be adaptively controlled by buffer control 209 during the encoding process to decrease the encoding complexity. If used buffer 205 approaches the size of audio input buffer 203 (i.e., available memory approaches a lower limit), the computational complexity of AMR-WB encoder 201 is reduced by decreasing the number of codebook search loops. Buffered audio data 205 can be compressed more quickly from buffer 203, even during the heavy computational peaks, and thus overflowing can be avoided. When buffer 203 is sufficiently empty and enough computational resources are available, a standard fixed number of codebook search iterations can be configured for normal operation during the encoding process.

### Algebraic Codebook

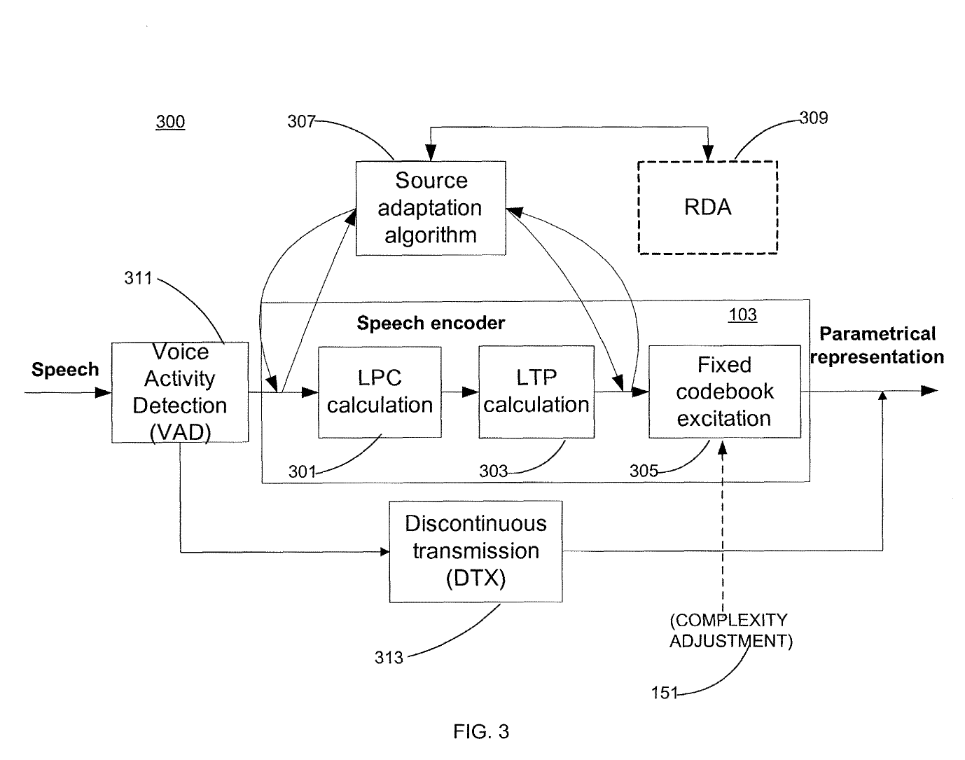

FIG. 3 shows wideband adaptive multi-rate (AMR) speech coding apparatus 300 in accordance with an embodiment of the invention. The embodiment supports variable and multi-rate speech coding. In addition, the embodiment supports scalable and variable rate coding, in which the bit rate may be changing from analysis frame to frame based on the source signal.

Speech encoding apparatus 300 is compatible with an AMR-WB speech codec as developed by 3GPP for GSM/EDGE and WCDMA channels, where the standardized codec is based on conventional ACELP technology. In addition, the standardized AMR-WB speech codec may be utilized in packet switched networks and in different kind of multimedia applications. The standardized AMR WB codec consists of different active speech modes with discontinuous transmission (DTX) functionality. The applied mode selection is based on the network capacity and radio channel conditions. However, the AMR WB codec may also be operated using a variable rate scheme.

As shown in FIG. 3, speech encoding apparatus 300 activates discontinuous transmission 313 based on voice activity detection 311. Speech encoder encoder 103 comprises LPC calculation 301 module (supporting short-term predication), LTP calculation module 303 (supporting long-term prediction) and fixed codebook excitation module 305. The number of iterations performed by fixed codebook excitation module 305 is determined by complexity adjustment 151.

Speech encoder 103 supports multi-rate configurations with independent coding modes. The applied mode selection is based on the network capacity and radio channel conditions. However, speech encoder 103 may also be operated using a variable rate scheme. While source adaptation (SA) extension is supported by source adaptation algorithm 307, the encoding mode may be selected independently for each analysis (encoding) frame (with 20 ms intervals) depending on the source signal characteristics as determined by rate determination algorithm (RDA) 309. The encoding process is also dependent on desired average bit rate target and supported mode set.

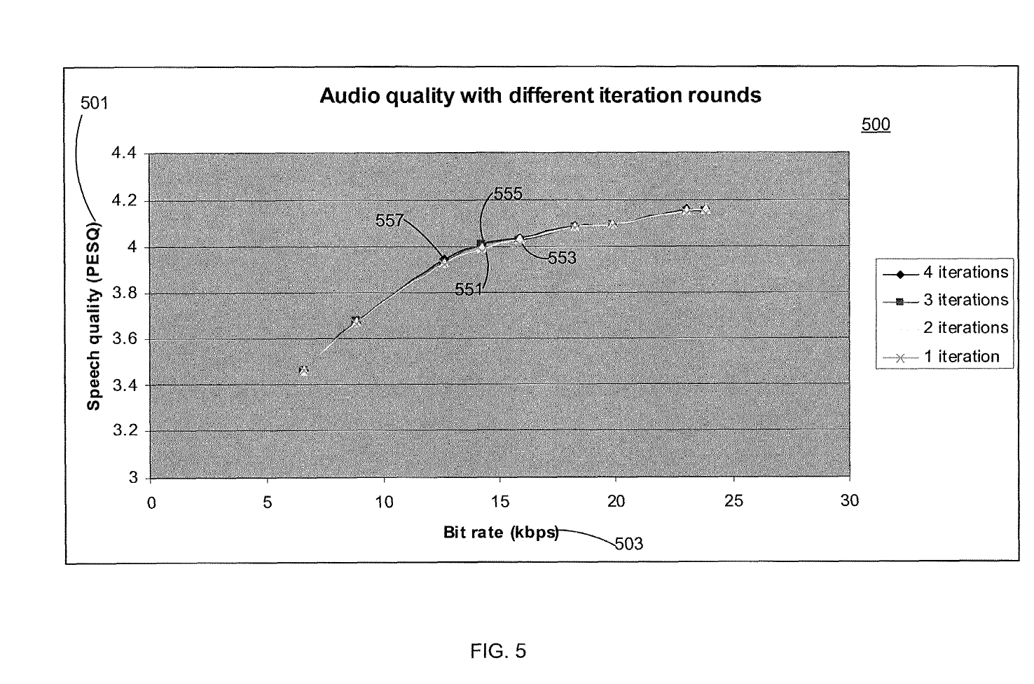

With an embodiment of the invention, the number of search iterations may be tuned based on computational load of mobile devices. By decreasing the number of iteration rounds, the AMR-WB encoding complexity, as performed by speech encoder 103, can be decreased with an acceptable degree of audio quality degradation. While AMR-WB encoding is a relatively complex algorithm that is executed on a mobile device platform, it may be important to decrease AMR-WB encoding complexity to enable simultaneous processes. An illustrative example is an AMR-WB encoder enabled audio recorder, where other playback or audio capture functionalities are supported (for example background music generation). By decreasing the number of iteration rounds, as will be further discussed, the AMR-WB encoding complexity can be decreased with a degree of audio quality degradation as shown in FIG. 5.

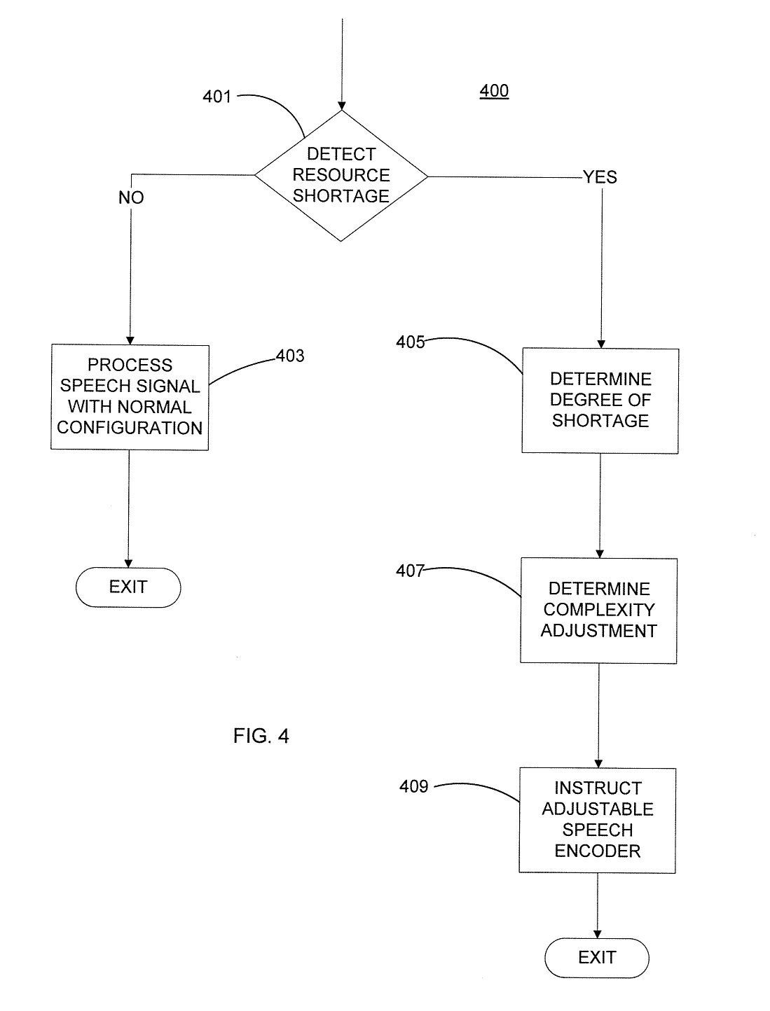

FIG. 4 shows flow diagram 400 for controlling a complexity adjustment of an adjustable speech encoder in accordance with an embodiment of the invention. In step 401, control module 101 (as shown in FIG. 1) detects whether there is a resource shortage, e.g., available processing capability or buffer memory. If not, step 403 maintains normal operation for adjustable speech encoder 103. If there is a detected resource shortage, step 405 determines a degree of the resource shortage and step 407 determines the reduced complexity for adjustable speech encoder 103. In step 409, complexity determination module 105 tunes adjustable speech encoder 103 to adjust the number of processing iteration. For example, if the available processing capability is 30% of the total processing capability, complexity determination module 105 may instruct adjustable speech encoder 103 to perform two iterations rather than four iterations when determining the codebook excitation.

While embodiments of the invention may reduce computational complexity of speech encoder 103 with a shortage of resources, embodiments of the invention may also increase the computational complexity when additional resources become available.

Embodiments of the invention are applicable to different user scenarios. For example, when a mobile device is recording something from in a user's environment (e.g., audio recording), the mobile device may receive an incoming video/phone call. The incoming call usually has the highest priority for the mobile device. The needed computational resources for the incoming call may have an impact on the computational resources available for recording process. Therefore, in this case, the mobile device can decrease the complexity of the audio encoder (e.g., adjustable speech encoder 103). Consequently, the mobile device can maintain the continuous recording process and also handle the incoming call at the same time. Embodiments of the invention support other scenarios, including recording/compressing something during a call (where the process has a higher priority in regards to computational resources).

### Codebook Structure

The codebook structure is based on interleaved single-pulse permutation (ISPP) design. The 64 positions in the codevector are divided into four tracks of interleaved positions, with 16 positions in each track. The different codebooks at the different rates are constructed by placing a certain number of signed pulses in the tracks (from one to six pulses per track). The codebook index, or codeword, represents the pulse positions and signs in each track. Thus, no codebook storage is needed, since the excitation vector at the decoder can be constructed through the information contained in the index itself (no lookup tables).

An important feature of the used codebook is that it is a dynamic codebook consisting of an algebraic codebook followed by an adaptive prefilter F(z) which enhances special spectral components in order to improve the synthesis speech quality. A prefilter relevant to wideband signals is used whereby F(z) consists of two parts: a periodicity enhancement part 1/(1−0.85z^{-T}) and a tilt part (1−β₁z⁻¹), where T is the integer part of the pitch lag and β₁ is related to the voicing of the previous subframe and is bounded by [0.0,0.5]. The codebook search is performed in the algebraic domain by combining the filter F(z) with the weighed synthesis filter prior to the codebook search. Thus, the impulse response h(n) must be modified to include the prefilter F(z). That is, h(n)←h(n)*f(n). The codebook structures of different bit rates are given below.

Based on the degree of a resource shortage, an adjustable speech encoder may be instructed to perform from one to four iterations when determining the codebook excitation for the following modes.

23.85 and 23.05 kbit/s Mode

In this codebook, the innovation vector contains 24 non-zero pulses. All pulses can have the amplitudes +1 or −1. The 64 positions in a subframe are divided into four tracks, where each track contains six pulses, as shown in Table 1.

TABLE 1
Potential positions of individual pulses in the algebraic
codebook, 23.85 and 23.05 kbit/s.

| Track | Pulse | Positions |
|---|---|---|
| 1 | i_{0,} i_{4,} i_{8,} i_{12,} i_{16,} i₂₀ | 0, 4, 8, 12, 16, 20, 24, 28, 32 36, 40, 44, 48, |
| | | 52, 56, 60 |
| 2 | i_{1,} i_{5,} i_{9,} i_{13,} i_{17,} i₂₁ | 1, 5, 9, 13, 17, 21, 25, 29, 33, 37, 41, 45, |
| | | 49, 53, 57, 61 |
| 3 | i_{2,} i_{6,} i_{10,} i_{14,} i_{18,} i₂₂ | 2, 6, 10, 14, 18, 22, 26, 30, 34, 38, 42, 46, |
| | | 50, 54, 58, 62 |
| 4 | i_{3,} i_{7,} i_{11,} i_{15,} i_{19,} i₂₃ | 3, 7, 11, 15, 19, 23, 27, 31, 35, 39, 43, 47, |
| | | 51, 55, 59, 63 |

The six pulses in one track are encoded with 22 bits. This gives a total of 88 bits (22+22+22+22) for the algebraic code.

19.85 kbit/s Mode

In this codebook, the innovation vector contains 18 non-zero pulses. All pulses can have the amplitudes +1 or −1. The 64 positions in a subframe are divided into four tracks, where each of the first two tracks contains five pulses and each of the other tracks contains four pulses, as shown in Table 2.

TABLE 2
Potential positions of individual pulses in the algebraic
codebook, 19.85 kbit/s.

| Track | Pulse | Positions |
|---|---|---|
| 1 | i_{0,} i_{4,} i_{8,} i_{12,} i₁₆ | 0, 4, 8, 12, 16, 20, 24, 28, 32 36, 40, 44, 48, 52, |
| | | 56, 60 |
| 2 | i_{1,} i_{5,} i_{9,} i_{13,} i₁₇ | 1, 5, 9, 13, 17, 21, 25, 29, 33, 37, 41, 45, |
| | | 49, 53, 57, 61 |
| 3 | i_{2,} i_{6,} i_{10,} i₁₄ | 2, 6, 10, 14, 18, 22, 26, 30, 34, 38, 42, 46, |
| | | 50, 54, 58, 62 |
| 4 | i_{3,} i_{7,} i_{11,} i₁₅ | 3, 7, 11, 15, 19, 23, 27, 31, 35, 39, 43, 47, |
| | | 51, 55, 59, 63 |

The five pulses in one track are encoded with 20 bits. The four pulses in one track are encoded with 16 bits. This gives a total of 72 bits (20+20+16+16) for the algebraic code.

18.25 kbit/s Mode

In this codebook, the innovation vector contains 16 non-zero pulses. All pulses can have the amplitudes +1 or −1. The 64 positions in a subframe are divided into four tracks, where each track contains four pulses, as shown in Table 3.

TABLE 3
Potential positions of individual pulses in the
algebraic codebook, 18.25 kbit/s.

| Track | Pulse | Positions |
|---|---|---|
| 1 | i_{0,} i_{4,} i_{8,} i₁₂ | 0, 4, 8, 12, 16, 20, 24, 28, 32 36, 40, |
| | | 44, 48, 52, 56, 60 |
| 2 | i_{1,} i_{5,} i_{9,} i₁₃ | 1, 5, 9, 13, 17, 21, 25, 29, 33, 37, 41, |
| | | 45, 49, 53, 57, 61 |
| 3 | i_{2,} i_{6,} i_{10,} i₁₄ | 2, 6, 10, 14, 18, 22, 26, 30, 34, 38, 42, |
| | | 46, 50, 54, 58, 62 |
| 4 | i_{3,} i_{7,} i_{11,} i₁₅ | 3, 7, 11, 15, 19, 23, 27, 31, 35, 39, 43, |
| | | 47, 51, 55, 59, 63 |

The four pulses in one track are encoded with 16 bits. This gives a total of 64 bits (16+16+16+16) for the algebraic code.

15.85 kbit/s Mode

In this codebook, the innovation vector contains 12 non-zero pulses. All pulses can have the amplitudes +1 or −1. The 64 positions in a subframe are divided into 4 tracks, where each track contains three pulses, as shown in Table 4.

TABLE 4
Potential positions of individual pulses in the
algebraic codebook, 15.85 kbit/s.

| Track | Pulse | Positions |
|---|---|---|
| 1 | i_{0,} i_{4,} i₈ | 0, 4, 8, 12, 16, 20, 24, 28, 32 36, 40, 44, |
| | | 48, 52, 56, 60 |
| 2 | i_{1,} i_{5,} i₉ | 1, 5, 9, 13, 17, 21, 25, 29, 33, 37, 41, 45, |
| | | 49, 53, 57, 61 |
| 3 | i_{2,} i_{6,} i₁₀ | 2, 6, 10, 14, 18, 22, 26, 30, 34, 38, 42, |
| | | 46, 50, 54, 58, 62 |
| 4 | i_{3,} i_{7,} i₁₁ | 3, 7, 11, 15, 19, 23, 27, 31, 35, 39, 43, |
| | | 47, 51, 55, 59, 63 |

The three pulses in one track are encoded with 13 bits. This gives a total of 52 bits (13+13+13+13) for the algebraic code.

14.25 kbit/s Mode

In this codebook, the innovation vector contains 10 non-zero pulses. All pulses can have the amplitudes +1 or −1. The 64 positions in a subframe are divided into four tracks, where each track contains two or three pulses, as shown in Table 5.

TABLE 5
Potential positions of individual pulses in the
algebraic codebook, 14.25 kbit/s.

| Track | Pulse | Positions |
|---|---|---|
| 1 | i_{0,} i_{4,} i₈ | 0, 4, 8, 12, 16, 20, 24, 28, 32 36, |
| | | 40, 44, 48, 52, 56, 60 |
| 2 | i_{1,} i_{5,} i₉ | 1, 5, 9, 13, 17, 21, 25, 29, 33, 37, |
| | | 41, 45, 49, 53, 57, 61 |
| 3 | i_{2,} i₆ | 2, 6, 10, 14, 18, 22, 26, 30, 34, 38, 42, |
| | | 46, 50, 54, 58, 62 |
| 4 | i_{3,} i₇ | 3, 7, 11, 15, 19, 23, 27, 31, 35, 39, 43, |
| | | 47, 51, 55, 59, 63 |

Each two pulse positions in one track are encoded with eight bits (four bits for the position of every pulse), and the sign of the first pulse in the track is encoded with one bit. The three pulses in one track are encoded with 13 bits. This gives a total of 44 bits (13+13+9+9) for the algebraic code.

12.65 kbit/s Mode

In this codebook, the innovation vector contains eight non-zero pulses. All pulses can have the amplitudes +1 or −1. The 64 positions in a subframe are divided into four tracks, where each track contains two pulses, as shown in Table 6.

TABLE 6
Potential positions of individual pulses in the
algebraic codebook, 12.65 kbit/s.

| Track | Pulse | Positions |
|---|---|---|
| 1 | i_{0,} i₄ | 0, 4, 8, 12, 16, 20, 24, 28, 32 36, 40, |
| | | 44, 48, 52, 56, 60 |
| 2 | i_{1,} i₅ | 1, 5, 9, 13, 17, 21, 25, 29, 33, 37, 41, |
| | | 45, 49, 53, 57, 61 |
| 3 | i_{2,} i₆ | 2, 6, 10, 14, 18, 22, 26, 30, 34, 38, 42, |
| | | 46, 50, 54, 58, 62 |
| 4 | i_{3,} i₇ | 3, 7, 11, 15, 19, 23, 27, 31, 35, 39, 43, |
| | | 47, 51, 55, 59, 63 |

Each two pulse positions in one track are encoded with eight bits (total of 32 bits, 4 bits for the position of every pulse), and the sign of the first pulse in the track is encoded with one bit (total of four bits). This gives a total of 36 bits for the algebraic code.

8.85 kbit/s Mode

In this codebook, the innovation vector contains four non-zero pulses. All pulses can have the amplitudes +1 or −1. The 64 positions in a subframe are divided into four tracks, where each track contains one pulse, as shown in Table 7.

TABLE 7
Potential positions of individual pulses in the
algebraic codebook, 8.85 kbit/s.

| Track | Pulse | Positions |
|---|---|---|
| 1 | i₀ | 0, 4, 8, 12, 16, 20, 24, 28, 32 36, 40, 44, 48, 52, 56, 60 |
| 2 | i₁ | 1, 5, 9, 13, 17, 21, 25, 29, 33, 37, 41, 45, 49, 53, 57, 61 |
| 3 | i₂ | 2, 6, 10, 14, 18, 22, 26, 30, 34, 38, 42, 46, 50, 54, 58, 62 |
| 4 | i₃ | 3, 7, 11, 15, 19, 23, 27, 31, 35, 39, 43, 47, 51, 55, 59, 63 |

Each pulse position in one track is encoded with four bits and the sign of the pulse in the track is encoded with one bit. This gives a total of 20 bits for the algebraic code.

6.60 kbit/s Mode

In this codebook, the innovation vector contains two non-zero pulses. All pulses can have the amplitudes +1 or −1. The 64 positions in a subframe are divided into two tracks, where each track contains one pulse, as shown in Table 8.

TABLE 8
Potential positions of individual pulses in the
algebraic codebook, 6.60 kbit/s.

| Track | Pulse | Positions |
|---|---|---|
| 1 | i₀ | 0, 2, 4, 6, 8, 10, 12, 14, 16, 18, 20, 22, 24, 26, 28, 30, 32, |
| | | 34, 36, 38, 40, 42, 44, 46, 48, 50, 52, 54, 56, 58, 60, 62 |
| 2 | i₁ | 1, 3, 5, 7, 9, 11, 13, 15, 17, 19, 21, 23, 25, 27, 29, 31, 33, |
| | | 35, 37, 39, 41, 43, 45, 47, 49, 51, 53, 55, 57, 59, 61, 63 |

Each pulse position in one track is encoded with 5 bits and the sign of the pulse in the track is encoded with one bit. This gives a total of 12 bits for the algebraic code.

### Pulse Indexing

In the above section, the number of bits needed to encode a number of pulses in a track was given. In this section, the procedures used for encoding from one to six pulses per track will be described. The description will be given for the case of four tracks per subframe, with 16 positions per track and pulse spacing of four (which is the case for all modes except the 6.6 kbit/s mode).

Encoding One Signed Pulse Per Track

The pulse position index is encoded with four bits and the sign index with one bit. The position index is given by the pulse position in the subframe divided by the pulse spacing (integer division). The division remainder gives the track index. For example, a pulse at position 31 has a position index of 31/4=7 and it belong to the track with index 3 (4^{th} track). The sign index here is set to 0 for positive signs and 1 for negative signs. The index of the signed pulse is given by

Iᵢₚ=p+s×2^{M} (EQ. 1)

where p is the position index, s is the sign index, and M=4 is the number of bits per track.

Encoding Two Signed Pulses Per Track

In case of two pulses per track of K=2^{M} potential positions (here M=4), each pulse needs one bit for the sign and M bits for the position, which gives a total of 2M+2 bits. However, some redundancy exists due to the unimportance of the pulse ordering. For example, placing the first pulse at position p and the second pulse at position q is equivalent to placing the first pulse at position q and the second pulse at position p. One bit can be saved by encoding only one sign and deducing the second sign from the ordering of the positions in the index. Here the index is given by

I₂ₚ=p₁+p₀×2^{M}+s×2^{2M} (EQ. 2)

where s is the sign index of the pulse at position index p₀. If the two signs are equal then the smaller position is set to p₀ and the larger position is set to p₁. On the other hand, of the two signs are not equal then the larger position is set to p₀ and the smaller position is set to p₁. At the decoder, the sign of the pulse at position p₀ is readily available. The second sign is deduced from the pulse ordering. If p₀ is larger than p₁ then the sign of the pulse at position p₁ is opposite to that at position p₀. If this is not the case then the two signs are set equal.

Encoding Three Signed Pulses Per Track

In case of three pulses per track, similar logic can be used as in the case of two pulses. For a track with 2^{M} positions, 3M+1 bits are needed instead of 3M+3 bits. A simple way of indexing the pulses is to divide the track positions in two sections (or halves) and identify a section that contains at least two pulses. The number of positions in the section is K/2=2^{M}/2=2^{M-1}, which can be represented with M−1 bits. The two pulses in the section containing at least two pulses are encoded with the procedure for encoding two signed pulses which requires 2(M−1)+1 bits and the remaining pulse which can be anywhere in the track (in either section) is encoded with the M+1 bits. Finally, the index of the section that contains the two pulses is encoded with one bit. Thus the total number of required bits is 2(M−1)+1+M+1+1=3M+1. A simple way of checking if two pulses are positioned in the same section is done by checking whether the most significant bits (MSB) of their position indices are equal or not. Note that a MSB of 0 means that the position belongs to the lower half of the track (0-7) and MSB of 1 means it belongs to the upper half (8-15). If the two pulses belong to the upper half, they need to be shifted to the range (0-7) before encoding them using 2×3+1 bits. This can be done by masking the M−1 least significant bits (LSB) with a mask consisting of M−1 ones (which corresponds to the number 7 in this case). The index of the 3 signed pulses is given by

I₃ₚ=I₂ₚ+k×2^{2M-1}+I₁ₚ×2^{2M} (EQ. 3)

where I₂ₚ is the index of the two pulses in the same section, k is the section index (0 or 1), and I₁ₚ is the index of the third pulse in the track.

Encoding Four Signed Pulses Per Track

The four signed pulses in a track of length K=2^{M} can be encoded using 4M bits. Similar to the case of three pulses, the K positions in the track are divided into two sections (two halves) where each section contains K/2=8 positions. Here we denote the sections as Section A with positions 0 to K/2−1 and Section B with positions K/2 to K−1. Each section can contain from zero to four pulses. Table 9, as shown below, shows the five cases representing the possible number of pulses in each section:

| case | Pulses in Section A | Pulses in Section B | Bits needed |
|---|---|---|---|
| 0 | 0 | 4 | 4M-3 |
| 1 | 1 | 3 | 4M-2 |
| 2 | 2 | 2 | 4M-2 |
| 3 | 3 | 1 | 4M-2 |
| 4 | 4 | 0 | 4M-3 |

In cases 0 or 4, the four pulses in a section of length K/2=2^{M-1} can be encoded using 4(M−1)+1=4M−3 bits (this will be explained later on). In cases 1 or 3, the one pulse in a section of length K/2=2^{M-1} can be encoded with M−1+1=M bits and the three pulses in the other section can be encoded with 3(M−1)+1=3M−2 bits. This gives a total of M+3M−2=4M−2 bits. In case 2, the pulses in a section of length K/2=2^{M-1} can be encoded with 2(M−1)+1=2M−1 bits. Thus for both sections, 2(2M−1)=4M−2 bits are required. The case index can be encoded with two bits (four possible cases) assuming cases 0 and 4 are combined. Then for cases 1, 2, or 3, the number of needed bits is 4M−2. This gives a total of 4M−2+2=4M bits. For cases 0 or 4, one bit is needed for identifying either case, and 4M−3 bits are needed for encoding the 4 pulses in the section. Adding the 2 bits needed for the general case, giving a total of 1+4M−3+2=4M bits. The index of the four signed pulses is given by

I₄ₚ=I_{AB}+k×2^{4M-2} (EQ. 4)

where k is the case index (2 bits), and I_{AB} is the index of the pulses in both sections for each individual case. For cases 0 and 1, I_{AB} is given by

I_{AB}_{_{—}}_{0,4}=I₄ₚ_{_{—}}_{section}+j×2^{4M-4} (EQ. 5)

where j is a 1-bit index identifying the section with 4 pulses and I₄ₚ_{_{—}}_{section} is the index of the four pulses in that section (which requires 4M−3 bits). For case 1, I_{AB} is given by

I_{AB}_{_{—}}_{I}=I₃ₚ_{_{—}}_{B}+I₁ₚ_{_{—}}_{A}×2^{3(M-}1)+1 (EQ. 6)

where I₃ₚ_{_{—}}_{B} is the index of the 3 pulses in Section B (3(M−1)+1 bits) and I₁ₚ_{_{—}}_{A} is the index of the pulse in Section A ((M−1)+1 bits). For case 2, I_{AB} is given by

I_{AB}_{_{—}}₂=I₂ₚ_{_{—}}_{B}+I₂ₚ_{_{—}}_{A}×2^{2(M-1)+1} (EQ. 7)

where I₂ₚ_{_{—}}_{B} is the index of the 2 pulses in Section B (2(M−1)+1 bits) and I₂ₚ_{_{—}}_{A} is the index of the two pulses in Section A (2(M−1)+1 bits). Finally, for case 3, I_{AB} is given by

I_{AB}_{_{—}}₃=I₁ₚ_{_{—}}_{B}+I₃ₚ_{_{—}}_{A}×2^{M} (EQ. 8)

where I₁ₚ_{_{—}}_{B} is the index of the pulse in Section B ((M−1)+1 bits) and I₃ₚ_{_{—}}_{A} is the index of the three pulses in Section A (3(M−1)+1 bits). For cases 0 and 4, it was mentioned that the four pulses in one section are encoded using 4(M−1)+1 bits. This is done by further dividing the section into 2 subsections of length K/4=2^{M-2} (=4 in this case); identifying a subsection that contains at least two pulses; coding the two pulses in that subsection using 2(M−2)+1=2M−3 bits; coding the index of the subsection that contains at least two pulses using one bit; and coding the remaining two pulses, assuming that they can be anywhere in the section, using 2(M−1)+1=2M−1 bits. This gives a total of (2M−3)+(1)+(2M−1)=4M−3 bits.

Encoding Five Signed Pulses Per Track

The five signed pulses in a track of length K=2^{M} can be encoded using 5M bits. Similar to the case of four pulses, the K positions in the track are divided into 2 sections A and B. Each section can contain from zero to five pulses. A simple approach to encode the five pulses is to identify a section that contains at least three pulses and to encode the three pulses in that section using 3(M−1)+1=3M−2 bits, and to encode the remaining two pulses in the whole track using 2M+1 bits. This gives 5M−1 bits. An extra bit is needed to identify the section that contains at least three pulses. Thus, a total of 5M bits are needed to encode the five signed pulses. The index of the five signed pulses is given by

₅ₚ=I₂ₚ+I₃ₚ×2^{2M}+k×2^{5M-1} (EQ. 9)

where k is the index of the section that contains at least three pulses, I₃ₚ is the index of the three pulses in that section (3(M−1)+1 bits), and I₂ₚ is the index of the remaining two pulses in the track (2M+1 bits).

Encoding Six Signed Pulses Per Track

The six signed pulses in a track of length K=2^{M} are encoded using 6M−2 bits. Similar to the case of five pulses, the K positions in the track are divided into 2 sections A and B. Each section can contain from zero to six pulses. Table 10, as shown below, shows the 7 cases representing the possible number of pulses in each sections:

| case | Pulses in Section A | Pulses in Section B | Bits needed |
|---|---|---|---|
| 0 | 0 | 6 | 6M-5 |
| 1 | 1 | 5 | 6M-5 |
| 2 | 2 | 4 | 6M-5 |
| 3 | 3 | 3 | 6M-4 |
| 4 | 4 | 2 | 6M-5 |
| 5 | 5 | 1 | 6M-5 |
| 6 | 6 | 0 | 6M-5 |

Note that cases 0 and 6 are similar except that the six pulses are in different section. Similarly, cases 1 and 5 as well as cases 2 and 4 differ only in the section that contains more pulses. Therefore these cases can be coupled and an extra bit can be assigned to identify the section that contains more pulses. Since these cases initially need 6M−5 bits, the coupled cases need 6M−4 bits taking into account the Section bit. Thus, we have now four states of coupled cases, that is (0,6), (1,5), (2,4), and (3),with 2 extra bits needed for the state. This gives a total of 6M−4+2=6M−2 bits for the six signed pulses. In cases 0 and 6, one bit is needed to identify the section which contains six pulses. five pulses in that section are encoded using 5(M−1) bits (since the pulses are confined to that section), and the remaining pulse is encoded using (M−1)+1 bits. Thus a total of 1+5(M−1)+M=6M−4 bits are needed for this coupled case. An extra two bits are needed to encode the state of the coupled case, giving a total of 6M−2 bits. For this coupled case, the index of the six pulses is given by

I₆ₚ=I₁ₚ+I₅ₚ×2^{M}+j×2^{6M-5}+k×2^{6M-4} (EQ. 10)

where k is the index of the coupled case (2 bits), j is the index of the section containing six pulses (1 bit), I₅ₚ is the index of five pulses in that section (5(M−1) bits), and I₁ₚ is the index of the remaining pulse in that section ((M−1)+1 bits). In cases 1 and 5, one bit is needed to identify the section which contains five pulses. The five pulses in that section are encoded using 5(M−1) bits and the pulse in the other section is encoded using (M−1)+1 bits. For this coupled case, the index of the six pulses is given by

I₆ₚ=I₁ₚ+I₅ₚ×2^{M}+j×2^{6M-5}+k×2^{6M-4} (EQ. 11)

where k is the index of the coupled case (2 bits), j is the index of the section containing five pulses (1 bit), I₅ₚ is the index of the five pulses in that section (5(M−1) bits), and I₁ₚ is the index of the pulse in the other section ((M−1)+1 bits). In cases 2 or 4, 1 bit is needed to identify the section which contains four pulses. The four pulses in that section are encoded using 4(M−1) bits and the two pulses in the other section are encoded using 2(M−1)+1 bits. For this coupled case, the index of the six pulses is given by

I₆ₚ=I₂ₚ+I₄ₚ×2^{2(M-1)+1}+j×2^{6M-5}+k×2^{6M-4} (EQ. 12)

where k is the index of the coupled case (2 bits), j is the index of the section containing four pulses (1 bit), I₄ₚ is the index of four pulses in that section (4(M−1) bits), and I₂ₚ is the index of the two pulses in the other section (2(M−1)+1 bits). In case 3, the three pulses in each section are encoded using 3(M−1)+1 bits in each Section. For this case, the index of the six pulses is given by

I₆ₚ=I_{3pB}+I_{3pA}×2^{3(M-1)+1}+k×2^{6M-4} (EQ. 13)

where k is the index of the coupled case (two bits), I_{3pB} is the index of three pulses Section B (3(M−1)+1 bits), and I_{3pA} is the index of the three pulses in Section A (3(M−1)+1 bits).

### Codebook Search

The algebraic codebook is searched by minimizing the mean square error between the weighted input speech and the weighted synthesis speech. The target signal used in the closed-loop pitch search is updated by subtracting the adaptive codebook contribution. Thus,

x₂(n)=x(n)−gₚy(n), n=0, . . . 63 (EQ. 14)

where y(n)=v(n)*h(n) is the filtered adaptive codebook vector and gₚ is the unquantized adaptive codebook gain. The matrix H is defined as the lower triangular Toeplitz convolution matrix with diagonal h(0) and lower diagonals h(1), . . . ,h(63), and d=H^{t}x₂ is the correlation between the target signal x₂(n) and the impulse response h(n) (also known as the backward filtered target vector), and Φ=H^{t}H is the matrix of correlations of h(n).

The elements of the vector d are computed by

$$d ( n ) {\sum }_{i = n}^{63} {x}_{2} ( i ) h ( i - n ) , n = 0 , … 63 , \qquad ( EQ . 15 )$$

and the elements of the symmetric matrix Φ are computed by

$$φ ( i , j ) = {\sum }_{n = j}^{63} h ( n - i ) h ( n - j ) , \\ i = 0 , … , 63 , j = i , … , 63. \qquad ( EQ . 16 )$$

### If cₖ is the algebraic codevector at index k, then the algebraic codebook is searched by maximizing the search criterion

$${Q}_{k} = \frac{{( {x}_{2}^{t} {Hc}_{k} )}^{2}}{{c}_{k}^{t} {H}^{t} {Hc}_{k}} = \frac{{( {d}^{t} {c}_{k} )}^{2}}{{c}_{k}^{t} Φ {c}_{k}} = \frac{{( {R}_{k} )}^{2}}{{E}_{k}} . \qquad ( EQ . 17 )$$

The vector d and the matrix Φ are usually computed prior to the codebook search. The algebraic structure of the codebooks allows for very fast search procedures since the innovation vector cₖ contains only a few nonzero pulses. The correlation in the numerator of Equation (43) is given by

$$C = {\sum }_{i = 0}^{{N}_{p} - 1} {a}_{i} d ( {m}_{i} ) \qquad ( EQ . 18 )$$

where mᵢ is the position of the ith pulse, aᵢ is its amplitude, and Nₚ is the number of pulses. The energy in the denominator of Equation (43) is given by

$$E = {\sum }_{i = 0}^{{N}_{p} - 1} φ ( {m}_{i} , {m}_{i} ) + 2 {\sum }_{i = 0}^{{N}_{p} - 2} {\sum }_{j = i + 1}^{{N}_{p} - 1} {a}_{i} {a}_{j} φ ( {m}_{i} , {m}_{j} ) \qquad ( EQ . 19 )$$

To simplify the search procedure, the pulse amplitudes are predetermined based on a certain reference signal b(n). In this so-called signal-selected pulse amplitude approach, the sign of a pulse at position i is set equal to the sign of the reference signal at that position. Here, the reference signal b(n) is given by

$$b ( n ) = \sqrt{\frac{{E}_{d}}{{E}_{r}}} {r}_{LTP} ( n ) + α d ( n ) \qquad ( EQ . 20 )$$

where E_{d}=d^{t}d is the energy of the signal d(n) and Eᵣ=r_{LTP}^{t}r_{LPT} is the energy of the signal r_{LTP}(n) which is the residual signal after long term prediction. The scaling factor α controls the amount of dependence of the reference signal on d(n), and it is lowered as the bit rate is increased. Here α=2 for 6.6 and 8.85 modes; α=1 for 12.65, 14.25, and 15.85 modes; α=0.8 for 18.25 mode; α=0.75 for 19.85 mode; and α=0.5 for 23.05 and 23.85 modes.

To simplify the search the signal d(n) and matrix Φ are modified to incorporate the pre-selected signs. Let s_{b}(n) denote the vector containing the signs of b(n). The modified signal d′(n) is given by

d′(n)=s_{b}(n)d(n) n=0, . . . ,N-1 (EQ. 21)

and the modified autocorrelation matrix Φ′ is given by

φ′(i,j)=s_{b}(i)s_{b}(j)φ(i,j), i=0, . . . ,N-1; j=i, . . . ,N-1. (EQ. 22)

### The correlation at the numerator of the search criterion Qₖ is now given by

$$R = {\sum }_{i = 0}^{{N}_{p} - 1} {d}^{′} ( {m}_{i} ) \qquad ( EQ . 23 )$$

and the energy at the denominator of the search criterion Qₖ is given by

$$E = {\sum }_{i = 0}^{{N}_{p} - 1} {φ}^{′} ( {m}_{i} , {m}_{i} ) + 2 {\sum }_{i = 0}^{{N}_{p} - 2} {\sum }_{j = i + 1}^{{N}_{p} - 1} {φ}^{′} ( {m}_{i} , {m}_{j} ) \qquad ( EQ . 24 )$$

The goal of the search now is to determine the codevector with the best set of Nₚ pulse positions assuming amplitudes of the pulses have been selected as described above. The basic selection criterion is the maximization of the above mentioned ratio Qₖ. In order to reduce the search complexity, a fast search procedure known as depth-first tree search procedure is used, whereby the pulse positions are determined Nₘ pulses at a time. More precisely, the Nₚ available pulses are partitioned into M non-empty subsets of Nₘ pulses respectively such that N₁+N₂ . . . +Nₘ . . . +N_{M}=Nₚ. A particular choice of positions for the first J=N₁+N₂ . . . +Nₘ₋₁ pulses considered is called a level-m path or a path of length J. The basic criterion for a path of J pulse positions is the ratio Qₖ(J) when only the J relevant pulses are considered.

The search begins with subset #1 and proceeds with subsequent subsets according to a tree structure whereby subset m is searched at the m^{th} level of the tree. The purpose of the search at level 1 is to consider the N₁ pulses of subset #1 and their valid positions in order to determine one, or a number of, candidate path(s) of length N₁ which are the tree nodes at level 1. The path at each terminating node of level m−1 is extended to length N₁+N₂ . . . +Nₘ at level m by considering Nₘ new pulses and their valid positions. One, or a number of, candidate extended path(s) are determined to constitute level-m nodes. The best codevector corresponds to that path of length Nₚ which maximizes the criterion Qₖ(Nₚ) with respect to all level-M nodes.

A special form of the depth-first tree search procedure is used here, in which two pulses are searched at a time, that is, Nₘ=2, and these 2 pulses belong to two consecutive tracks. Further, instead of assuming that the matrix Φ is precomputed and stored, which requires a memory of N×N words (64×64=4 k words), a memory-efficient approach is used which reduces the memory requirement. In this approach, the search procedure is performed in such a way that only a part of the needed elements of the correlation matrix are precomputed and stored. This part corresponds to the correlations of the impulse response corresponding to potential pulse positions in consecutive tracks, as well as the correlations corresponding to φ(j,j), j=0, . . . ,N-1 (that is the elements of the main diagonal of matrix Φ).

In order to reduce complexity, while testing possible combinations of two pulses, a limited number of potential positions of the first pulse are tested. Further, in case of large number of pulses, some pulses in the higher levels of the search tree are fixed. In order to guess intelligently which potential pulse positions are considered for the first pulse or in order to fix some pulse positions, a “pulse-position likelihood-estimate vector” b is used, which is based on speech-related signals. The p^{th} component b(p) of this estimate vector b characterizes the probability of a pulse occupying position p(p=0, 1, . . . N-1) in the best codevector we are searching for. Here the estimate vector b is the same vector used for preselecting the amplitudes and given in Equation (46).

The search procedures for all bit rate modes are similar. Two pulses are searched at a time, and these two pulses always correspond to consecutive tracks. That is the two searched pulses are in tracks T₀-T₁, T₁-T₂, T₂-T₃, or T₃-T₀. Before searching the positions, the sign of at pulse a potential position n is set the sign of b(n) at that position.

Then the modified signal d′(n) is computed as described above by including the predetermined signs. For the first two pulses (1^{st} tree level), the correlation at the numerator of the search criterion is given by

R=d′(m₀)+d′(m₁) (EQ. 25)

and the energy at the denominator of the search criterion Qₖ is given by

E=φ′(m₀,m₀)+φ′(m₁,m₁)+2φ′(m₀,m₁) (EQ. 26)

where the correlations φ′(mᵢ,mⱼ) has been modified to include the preselected signs at positions mᵢ and mⱼ.

For subsequent levels, the numerator and denominator are updated by adding the contribution of two new pulses. Assuming that two new pulses at a certain tree level with positions mₖ and mₖ₊₁ from two consecutive tracks are searched, then the updated value of R is given by

R=R+d′(mₖ)+d′(mₖ₊₁) (EQ. 27)

and the updated energy is given by

E=E+φ′(mₖ,mₖ)+φ′(mₖ₊₁,mₖ₊₁)+2φ′(mₖ,mₖ₊₁)+2Rₕᵥ(mₖ)+2Rₕᵥ(mₖ₊₁) (EQ. 28)

where Rₕᵥ(m) is the correlation between the impulse response h(n) and a vector vₕ(n) containing the addition of delayed versions of impulse response at the previously determined positions. That is,

$$\begin{matrix}{v}_{h} ( n ) = {\sum }_{i = 0}^{k - 1} h ( n - {m}_{i} ) and & ( EQ . 29 ) \\ {R}_{hv} ( m ) = {\sum }_{n = m}^{N - 1} h ( n ) {v}_{h} ( n - m ) & ( EQ . 30 )\end{matrix}$$

At each tree level, the values of Rₕᵥ(m) are computed online for all possible positions in each of the two tracks being tested. It can be seen from Equation (48) that only the correlations φ′(mₖ,mₖ₊₁) corresponding to pulse positions in two consecutive tracks need to be stored (4×16×16 words), along with the correlations φ′(mₖ,mₖ) corresponding to the diagonal of the matrix Φ (64 words). Thus the memory requirement in the present algebraic structure is 1088 words instead of 64×64=4096 words. The search procedures at the different bit rates modes are similar. The difference is in the number of pulses, and accordingly, the number of levels in the tree search. In order to keep a comparable search complexity across the different codebooks, the number of tested positions is kept similar.

The search in the 12.65 kbit/s mode will be described as an example. In this mode, 2 pulses are placed in each track giving a total of 8 pulses per subframe of length 64. Two pulses are searched at a time, and these two pulses always correspond to consecutive tracks. That is the two searched pulses are in tracks T₀-T₁, T₁-T₂, T₂-T₃, or T₃-T₀. The tree has 4 levels in this case. At the first level, pulse P₀ is assigned to track T₀ and pulse P₁ to track T₁. In this level, no search is performed and the two pulse positions are set to the maximum of b(n) in each track. In the second level, pulse P₂ is assigned to track T₂ and pulse P₃ to track T₃. four positions for pulse P₂ are tested against all 16 positions of pulse P₃. The four tested positions of P₂ are determined based on the maxima of b(n) in the track. In the third level, pulse P₄ is assigned to track T₁ and pulse P₅ to track T₂. Eight positions for pulse P₄ are tested against all 16 positions of pulse P₅. Similar to the previous search level, the 8 tested positions of P₄ are determined based on the maxima of b(n) in the track. In the fourth level, pulse P₆ is assigned to track T₃ and pulse P₇ to track T₀. Eight positions for pulse P₆ are tested against all 16 positions of pulse P₇. Thus, the total number of tested combination is 4×16+8×16+8×16=320. The whole process is repeated from one to four times (one to four iterations) by assigning the pulses to different tracks. For example, in the 2^{nd} iteration, pulses P₀ to P₇ are assigned to tracks T₁, T₂, T₃, T₀, T₂, T₃, T₀, and T₁, respectively. Thus, the total number of tested position combinations is 4×320=1280.

As another search example, in the 15.85 kbit/s mode, three pulses are placed in each track giving a total of 12 pulses. There are six levels in the tree search whereby two pulses are searched in each level. In the first two levels, four pulses are set to the maxima of b(n). In the subsequent four levels, the number of tested combinations are 4×16, 6×16, 8×16, and 8×16, respectively. Based on the degree of a resource shortage, one to four iterations may be preformed by the adjustable speech encoder. When four iterations are used, there are a total of 4×26×16=1664 combinations.

Performance Evaluation

FIG. 5 shows audio quality in relation to a number of iterations in accordance with an embodiment of the invention. Relationship 500 relates the speech quality 501 to the variable bit rate (which varies with the speech encoder mode) for different numbers of iterations. (Speech quality 501 varies from 0 to 5, where 4 corresponds to toll quality and 5 is the best possible quality.) Curves 551, 553, 555, and 557 correspond to one, two, three, and four iterations, respectively. Relationship 500 suggests that the degradation of the speech quality may be kept at an acceptable level with the reduction of the computational complexity.

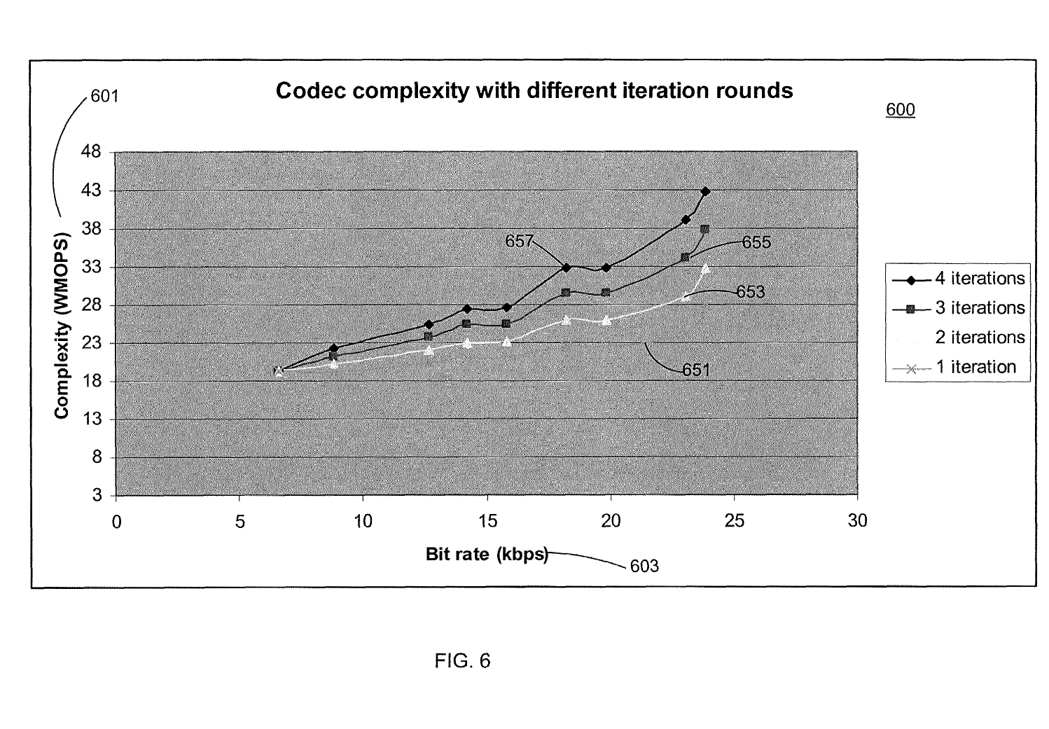

FIG. 6 shows speech encoder computational complexity in relation to a number of iterations in accordance with an embodiment of the invention. Relationship 600 relates the computational complexity 601 as a function of the variable bit rate 603 (which varies with the speech encoder mode) for different numbers of iterations. Relationship 600 suggests that the reduction of computational complexity may be significant, particularly with higher bit rates (corresponding to 23.85 and 23.05 kbit/s mode and 19.85 kbit/s mode).

### ILLUSTRATIVE EXAMPLES

As discussed above, the computational complexity of an adjustable speech encoder is a function of a resource shortage. Also, embodiments of the invention may be utilized with a low battery life time. In this case, all the recording/compression activities can be processed by using complexity adjustment while the battery is being recharged. As shown in FIG. 1, embodiments of the invention are practical when simultaneous application is running. Also, a complexity adjustment of the encoder can be utilized when extra video/audio/picture enhancement algorithms are used or during the recording/compression of the content. Moreover, the start up of an application may need extra computational resources and may cause a temporary computational peak and therefore temporary resource shortage.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A computer-readable medium having computer-executable instructions comprising:
(a) determining a resource availability;
(b) in response to (a), determining a degree of the resource availability;
(c) determining a complexity adjustment based on the degree of the resource availability; and
(d) tuning an adjustable signal encoder in accordance with the complexity adjustment.

2. The computer-readable medium of claim 1, wherein:
the resource availability corresponds to a resource shortage;
the degree of the resource availability corresponds to a degree of the resource shortage;
the adjustable signal encoder comprises an adjustable speech encoder; and
(a) comprises:
detecting the resource shortage.

3. The computer-readable medium of claim 2, wherein:
the resource shortage is associated with a computational load; and
(c) comprises:
(c)(i) reducing a computational complexity of a speech processing algorithm being executed by the adjustable speech encoder with an increased degree of the computational load.

4. The computer-readable medium of claim 2, wherein
the resource shortage is associated with available audio buffer memory; and
(c) comprises:
(c)(i) reducing a computational complexity of a speech processing algorithm being executed by the adjustable speech encoder as the available audio buffer memory is reduced.

5. The computer-readable medium of claim 2, wherein
the resource shortage is associated with available battery energy; and
(c) comprises:
(c)(i) reducing a computational complexity of a speech processing algorithm being executed by the adjustable speech encoder as the available battery energy is reduced.

6. The computer-readable medium of claim 2, wherein (d) comprises:
(d)(i) determining a number of iteration rounds performed by the adjustable speech encoder when executing a speech processing algorithm.

7. The computer-readable medium of claim 6, wherein:
the speech processing algorithm utilizes ACELP technology; and
the number of iteration rounds corresponds to algebraic codebook search iterations.

8. The computer-readable medium of claim 7, wherein (d)(i) comprises:
(d)(i)(1) when the degree of resource shortage is greater than a first level and less than a second level, setting the number of iteration rounds to a first number.

9. The computer-readable medium of claim 8, wherein (d)(i) comprises:
(d)(i)(2) when the degree of resource shortage is greater than the second level, setting the number of iteration rounds to a second number.

10. The computer-readable medium of claim 2, wherein (c) comprises:
(c)(i) when the resource shortage has ended, changing the complexity adjustment to return the adjustable speech encoder to a normal operation.

11. The computer-readable medium of claim 2, further comprising:
(e) repeating (a)-(d) for each encoding frame.

12. The computer-readable medium of claim 2, further comprising:
(e) scheduling a process having a higher priority than speech encoding; and
wherein (b) comprises:
(b)(i) including resource usage of the process when determining the degree of the resource shortage.

13. The computer-readable medium of claim 1, wherein the adjustable signal encoder comprises an adjustable video encoder.

14. The computer-readable medium of claim 1, wherein:
the adjustable signal encoder comprises an adjustable speech encoder;
(a) comprises:
determining an increase of the resource availability; and
(c) comprises:
determining an increased complexity adjustment based on the degree of the resource availability; and
(d) comprises:
tuning the adjustable speech encoder in accordance with the increased complexity adjustment.

15. A computer-readable medium having computer-executable instructions comprising:
(a) receiving an indication corresponding to a complexity adjustment; and
(b) adjusting a computational complexity of a speech processing algorithm being executed by an adjustable speech encoder based on the complexity adjustment.

16. The computer-readable medium of claim 15, wherein (b) comprises:
(b)(i) adjusting a number of iteration rounds performed by the adjustable speech encoder when executing a speech processing algorithm.

17. The computer-readable medium of claim 16, wherein:
the speech processing algorithm utilizes ACELP technology; and
the number of iteration rounds corresponds to algebraic codebook search iterations.

18. An apparatus comprising:
a control module configured to determine a resource indication from a degree of a resource shortage; and
a complexity determination module configured to determine a complexity adjustment from the resource indication and configured to tune an adjustable speech encoder to adjust a computational complexity of a speech processing algorithm being executed by the adjustable speech encoder.

19. The apparatus of claim 18, the control module configured to determine a computational load and to determine the computational complexity based on the computation loading.

20. The apparatus of claim 18, the control module configured to determine an amount of available audio buffer memory and to determine the computational complexity based on the amount of available audio buffer memory.

21. The apparatus of claim 18, the control module configured to determine an amount of available battery energy and to determine the computational complexity based on the amount of available battery energy.

22. The apparatus of claim 18, the complexity determination module configured to determine a number of iteration rounds performed by the adjustable speech encoder when executing a speech processing algorithm.

23. An apparatus comprising:
a control module configured to determine a degree of a resource shortage and to provide a resource indication from the degree of the resource shortage;
a complexity determination module configured to a complexity adjustment from the resource indication and to tune an adjustable speech encoder to adjust a computational complexity of a speech processing algorithm being executed by the adjustable speech encoder; and
the adjustable speech encoder configured to receive the complexity adjustment and to adjust a number of iteration rounds when executing the speech processing algorithm based on the complexity adjustment.

24. A method comprising:
(a) determining a resource availability;
(b) in response to (a), determining a degree of the resource availability;
(c) determining a complexity adjustment based on the degree of the resource availability; and
(d) tuning an adjustable signal encoder in accordance with the complexity adjustment.

25. The method of claim 24, wherein:
the resource availability corresponds to a resource shortage;
the degree of the resource availability corresponds to a degree of the resource shortage;
the adjustable signal encoder comprises an adjustable speech encoder; and
(a) comprises:
detecting the resource shortage.

26. An apparatus comprising:
(a) means for determining a resource availability;
(b) means for determining a degree of the resource availability in response to (a);
(c) means for determining a complexity adjustment based on the degree of the resource availability; and
(d) means for tuning an adjustable signal encoder in accordance with the complexity adjustment.

27. The apparatus of claim 26, wherein the resource availability corresponds to a resource shortage, the degree of the resource availability corresponds to a degree of the resource shortage, and the adjustable signal encoder comprises an adjustable speech encoder, the apparatus further comprising:
means for detecting the resource shortage.
